(19) United States
(12) Patent Application Publication
(10) Pub. No.: US 2026/0368855 A1
(43) Pub. Date: Nov. 19, 2026

(54) SURROUND VIEW SYSTEM FOR A VEHICLE

(71) Applicant: Continental Autonomous Mobility Germany GmbH, Ingolstadt (DE)

(72) Inventors: Pavan Nag Prabhakar, Auburn Hills, MI (US); Chetan Gotur, Bangalore (IN)

(73) Assignee: Continental Autonomous Mobility Germany GmbH, Ingolstadt (DE)

(21) Appl. No.: 19/135,629

(22) PCT Filed: Aug. 29, 2023
(86) PCT No.: PCT/EP2023/073613

§ 371 Date: Jun. 4, 2025

(30) Foreign Application Priority Data
Dec. 5, 2022 (GB) 2218221.6

(51) Int. Cl. G06T 5/50; G06T 7/80; G06V 20/56

(52) U.S. Cl. CPC G06T 5/50; G06T 7/80; G06V 20/56; G06T 2207/30252

(57) ABSTRACT

A vehicle surround view system includes a processing unit receiving first optical sensor data from an optical sensor. The optical sensor data contain first data where the optical sensor has a first angle with respect to the vehicle body. The processing unit calibrates the optical sensor using the first optical sensor data, constructs a view using the first optical sensor data of the calibrated optical sensor, and renders a surround view. The processing unit receives second optical sensor data from the optical sensor. The second optical sensor data contain second data where the optical sensor has a second angle with respect to the vehicle body. The processing unit estimates the difference of the first angle and the second angle, reconstruct the view of the optical sensor using the second optical sensor data of the optical sensor having the second angle, and renders the surround view using the reconstructed view.

### CROSS REFERENCE TO RELATED APPLICATIONS

This application is the U.S. National Phase Application of PCT International Application No. PCT/EP2023/073613, filed Aug. 29, 2023, which claims priority to Great Britain Patent Application No. 2218221.6, filed Dec. 5, 2022, the contents of such applications being incorporated by reference herein.

### FIELD OF THE INVENTION

The invention relates to a surround view system for a vehicle, a usage of a processing unit in a surround view system for a vehicle, a method for rendering a surround view of a vehicle, a vehicle comprising such a surround view system, a computer program and a non-transitory computer readable medium.

### BACKGROUND OF THE INVENTION

Vehicle surround view systems rely on a static installation including relative positions and angles with respect to the vehicle body of their cameras. The cameras are calibrated to these positions and angles. A change of a relative position or an angle might lead to a distorted view, blind spots and other effects, which disturb the surround view or make the view of a camera unusable and the surround view incomplete.

### SUMMARY OF THE INVENTION

There may be a desire to provide an improved surround view system.

This desire is met by the subject-matters of the independent patent claims.

Advantageous embodiments are the subject of the dependent claims, the following description, and the figures.

The described embodiments similarly relate to the surround view system for a vehicle, the usage of a processing unit in a surround view system for a vehicle, the method for rendering a surround view of a vehicle, the vehicle comprising such a surround view system, the computer program and the non-transitory computer readable medium. Synergistic effects may result from various combinations of the embodiments, although they may not be described in detail.

It should also be noted that all embodiments of the present disclosure involving a process may be carried out in the order of steps described, but this need not be the sole and essential order of the steps of the process. The methods disclosed herein may be carried out with a different order of the disclosed steps without departing from the particular method embodiment, unless otherwise expressly stated below.

According to a first aspect, a surround view system for a vehicle is provided. The surround view system comprises a processing unit, which is configured to receive first optical sensor data from an optical sensor. The optical sensor data contain first data where the optical sensor has a first angle with respect to the vehicle body. The processing unit is further configured to calibrate the optical sensor using the first optical sensor data, to construct a view using the first optical sensor data of the calibrated optical sensor, and to render a surround view using the view. The processing unit is further configured to receive second optical sensor data from the optical sensor. The second optical sensor data contain second data where the optical sensor has a second angle with respect to the vehicle body. The processing unit is further configured to estimate the difference of the first angle and the second angle, to reconstruct the view of the optical sensor using the second optical sensor data of the optical sensor having the second angle, and to render the surround view using the reconstructed view.

The term “first data” relates to optical sensor data, i.e., image data that are captured when the camera is not pivoted. Correspondingly, the term “second data” relates to optical sensor data, i.e., image data that are captured when the optical sensor is pivoted. It is understood, that the surround view is updated repeatedly a plurality of times with further first data, when the optical sensor is not pivoted, and updated repeatedly a plurality of times with further second data, i.e. further image data, when the optical sensor is pivoted.

By estimating the difference of the first angle and the second angle, it is clear for a skilled person, that the second angle can be determined, and that a view with the second angle can be transformed to a view with a first angle. For example, transformation matrices or rotation matrices may be used to transform a view with a second angle to a view with a first angle.

The first and second angles may relate to a common local vehicle coordination system.

A surround view system of a vehicle composes a, for example 360° surround view using a plurality of single views. Each single view is obtained by a respective camera capturing a section of the total surround view. The sections of the plurality of cameras usually overlap and the processing unit recognizes overlapping areas and matches them to combine or merge adjacent views. Areas not covered by any of the views can be, for example, interpolated if the area is small, or drawn as a solid color area or pattern, for example. The cameras are calibrated such that their relative position and, in particular, the orientation is exactly defined, so that the images of the different cameras can be merged seamlessly and the presented objects can be displayed at a correct angle and position on the surround view. If one of the plurality of cameras is rotated, according to the state of the art, the images of this camera are incorporated incorrectly into the surround view. If the processing unit is not able to match the image into the surround view, the complete image is discarded resulting in a blind spot. Such a blind spot may therefore affect for example the view a complete side such as the left or the right side of the vehicle. The processing unit of the present disclosure is configured to overcome the problem that the image cannot be matched such that the views cannot be combined anymore and a blind spot occurs. For that, the processing unit takes into account that the second data is data of a view at a different angle. The processing unit “corrects” the view such that it rotates the view from the second angle to a view of the first angle. This enables the processing to find matching areas of the views and to project the presented objects with the second angle into objects with a first angle. The processing unit then can process the view and find matching adjacent areas so that the views of the plurality of cameras can be combined and used for rendering the surround view. Since the view of the pivoted or rotated camera might not cover the complete side of the vehicle, there might still remain a blind spot. However, this remaining blind spot is small compared to the blind spot caused by discarding the complete view or image of the pivoted camera. The camera may be a camera arranged, for example, at a door of a vehicle. An event related to pivoting the camera is, for example, an action leading to an opening of the door, a vehicle movement or the actuation of the door itself. Therefore, the “event” in this example is not necessarily the opening of the door itself but an event, which may be followed by the opening of the door.

The processing unit may be part of a human-machine-interface (HMI) or a driving assistance system. The processing unit may further comprise one or more processors capable for processing signals, images, videos and/or for providing data and signals to a display. The processing unit may further comprise interfaces to, for example, a data storage and to external units, such as other driving assistance systems and/or directly or indirectly accessible sensor units.

When, for example, the door is opened, the camera follows a circular curve with the midpoint being the hinge of the door and performs a change in both, position and orientation of the camera, which can be expressed as a combination of rotation and translation. The term “pivot” takes into account such a movement but may also include a rotation only.

According to an embodiment, the surround view system further comprises the optical sensor, wherein the optical sensor is mounted on a pivotable part of the vehicle body.

Pivotable parts may be, for example, doors, a retractable mirror, or a trunk lid. The optical sensor may be a camera such as a digital or analog camera, or a device using, for example CCD or CMOS chips.

According to an embodiment, the event is a change of a vehicle state, and the processing unit is further configured monitor the vehicle state, and to perform the receiving first optical sensor data from an optical sensor, the calibrating the optical sensor using the first optical sensor data and the constructing a view using the optical sensor data of the calibrated optical sensor and rendering the surround view using the view, when the processing unit detects that the vehicle is in a first vehicle state. The processing unit is further configured to perform the receiving second optical sensor data from the optical sensor, the estimating the difference of the first angle and the second angle, and the reconstructing the view of the optical sensor and rendering the surround view using the reconstructed view, when the processing unit detects that the vehicle is in a second vehicle state.

That is, the event is detected by monitoring the vehicle state. Before the event occurs, the surround view is composed of the images of the calibrated cameras without change regarding the orientation of the camera. After the event has occurred, the rotation angle is estimated and the surround view is rendered using the reconstructed view.

According to an embodiment, the vehicle state is whether the electrical system is switched on or off, the motor is running or not running, and/or the vehicle is moving or not moving.

For example, a door may be opened when a vehicle stops or shortly after a vehicle has been stopped. As another example, the mirrors on the side of a vehicle may be retracted when the electrical system and/or the electrical system is switched on when inserting the key into the ignition lock.

According to an embodiment, the processing unit is further configured to detect the event, such as the change of the vehicle state, using the optical sensor data sensed by the optical sensor, which may pivot.

For example, the processing unit evaluates the images that show a movement relative to a road and which therefore indicate that the motor is on and that the vehicle is moving. As another example, the processing unit evaluates the images of an optical sensor mounted at a side mirror or a door and detects that the images show an increasing part of the vehicle body. In a further example, the processing unit detects a speed of relative rotation of objects in the surrounding that is higher than that of the vehicle driving along a curve.

According to an embodiment, the processing unit is further configured to detect the event using external vehicle data or external sensor data.

The external vehicle data may be received from devices, sensors or a control unit of the vehicle, which are external to the surround view system but inside or attached to the vehicle. The external data may further be received from auxiliary devices such as a navigation system or a driver assistance system. The data may contain, for example, information about the movement of the vehicle, whether the electrical system is switched on, or the motor is on. The movement information may be, for example, information about a speed, an angle of the wheels, or a path of the vehicle. The term “data” includes also digital or analog signals in this disclosure.

According to an embodiment, the event is a pivoting of the pivotable part, and the processing unit is further configured to detect the pivoting of the pivotable part by receiving external sensor data.

Again, the term “external” means external with respect to the surround view system. The external sensor data is provided, for example from one or more sensors detecting whether a door is closed, such as a Hall sensor or a contact sensor or a proximity sensor, or a control device for an actuator for, for example retracting a side mirror. The control device may have a communication or signal link to the processing unit for indicating an actuation. The control device may also provide information about a rotation angle of the controlled device.

According to an embodiment, the processing unit is further configured to estimate the difference between the first and the second angle using stored vehicle data and/or external sensor data.

The difference between the first and the second angle may be, for example, binary, relating to a binary monitored vehicle state. For example, the possible vehicle states that are detected by the processing unit may be “vehicle is moving” and “vehicle is not moving”. Since, in this example, no further state information is available, the difference between the first and the second angle is translated into a “door closed” angle, for example 0°, or a “door opened” angle, for example, 70°. This information may be contained in a data storage of a device of the vehicle, which is accessed by the processing unit, or may be contained in a data storage of the surround view system. However, the processing unit may also receive and use measurement data of a sensor that measures the current door opening angle. The processing unit then may calculate the view according to this angle information.

According to an embodiment, the pivotable part of the vehicle body is a door of the vehicle.

The door may be, for example the door next to the seat of the driver or of the passengers. If external sensor data are used, the sensors may provide information which seat is occupied. Further, a seat belt sensor may provide information, on which seat a release of the seat belt has occurred and therefore an opening of the door can be assumed.

According to an embodiment, the surround view system comprises further a plurality of optical sensors, and the processing unit is further configured to receive optical data from the plurality of optical sensors and to render the surround view system using further the optical data of the plurality of optical sensors.

The further optical sensors may be mounted, for example, on the front side, the rear side, the edges or anywhere else at the vehicle body.

According to a further aspect, a usage of a processing unit in a surround view system for a vehicle is provided. The processing unit receives first optical sensor data from an optical sensor. The optical sensor data contain first data where the optical sensor has first angle with respect to the vehicle body, calibrates the optical sensor using the first optical sensor data, and constructs a view using the optical sensor data of the calibrated optical sensor. The processing unit detects an event related to pivoting the optical sensor and receives upon detecting the event second optical sensor data from the optical sensor. The second optical sensor data contain second data where the optical sensor has a second angle with respect to the vehicle body. The processing unit estimates the difference of the first angle and the second angle, and reconstructs the surround view using the second optical sensor data of the optical sensor having the second angle and renders the surround view using the reconstructed view.

According to a further aspect, a method for rendering a surround view of a vehicle is provided. The method comprises the following steps. In a first step, first optical sensor data are received by the processing unit from an optical sensor, the first optical sensor data containing first data where the optical sensor has first angle with respect to the vehicle body. In a next step, the optical sensor is calibrated by the processing unit using the first optical sensor data and a view is constructed using the first optical sensor data of the calibrated optical sensor. In a next step, an event related to pivoting the optical sensor is detected. In a further step, upon detecting the event, second optical sensor data are received from the optical sensor, the second optical sensor data containing second data where the optical sensor has a second angle with respect to the vehicle body. In a next step, the difference of the first angle and the second angle is estimated. In a further step, the view of the optical sensor is reconstructed using the second optical sensor data of the optical sensor having the second angle and the surround view is rendered using the reconstructed view. By reconstructing the view and using this view, the previous view is discarded or at least not used for rendering the surround view.

If the event related to pivoting the optical sensor is not detected, the surround view is rendered using the view, i.e., an angle has to be determined and the view has not to be re-constructed.

According to a further aspect, a vehicle comprising a surround view system as described herein is provided.

According to a further aspect, a program is provided that, when executed by a processor, causes the processor to implement the method for rendering a surround view of a vehicle as described herein.

According to a further aspect, a non-transitory computer readable medium having stored thereon a program that when executed by a processor causes the processor to implement the method for rendering a surround view of a vehicle is provided.

The computer readable medium may be seen as a storage medium or memory device, such as for example, a USB stick, a CD, a DVD, a data storage device, a hard disk, or any other medium on which a program element as described above can be stored. In the embodiments described herein, a memory device may include, but is not limited to, a non-transitory computer-readable medium, such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROMs, DVDs, and any other digital source such as a network or the Internet, as well as yet to be developed digital means, with the sole exception being a transitory, propagating signal. Alternatively, a floppy disk, a compact disc-read only memory (CD-ROM), a magneto-optical disk (MOD), a digital versatile disc (DVD), or any other computer-based device implemented in any method or technology for short-term and long-term storage of information, such as, computer-readable instructions, data structures, program modules and sub-modules, or other data may also be used. Therefore, the methods described herein may be encoded as executable instructions, e.g., “software” and “firmware,” embodied in a non-transitory computer-readable medium. Further, as used herein, the terms “software” and “firmware” are interchangeable, and include any computer program stored in memory for execution by personal computers, workstations, clients and servers. Such instructions, when executed by a processor, cause the processor to perform at least a portion of the methods described herein.

These and other features, aspects and advantages of aspects of the present invention will become better understood with reference to the accompanying figures and the following description.

### BRIEF DESCRIPTION OF THE DRAWINGS

FIG. 1 shows a sketch of an ideal surround view,

FIG. 2A shows a sketch of the surround view where the camera is pivoted,

FIG. 2B shows a sketch of the surround view where the camera view of the pivoted camera is eliminated,

FIG. 3 shows a sketch of the surround view after correction,

FIG. 4 shows a flow diagram of a method for rendering a surround view of a vehicle,

FIG. 5 shows a block diagram of a surround view system,

FIG. 6 shows a block diagram of a method for rendering a surround view of a vehicle.

### DESCRIPTION OF EXEMPLARY EMBODIMENTS

Corresponding parts are provided with the same reference symbols in all figures.

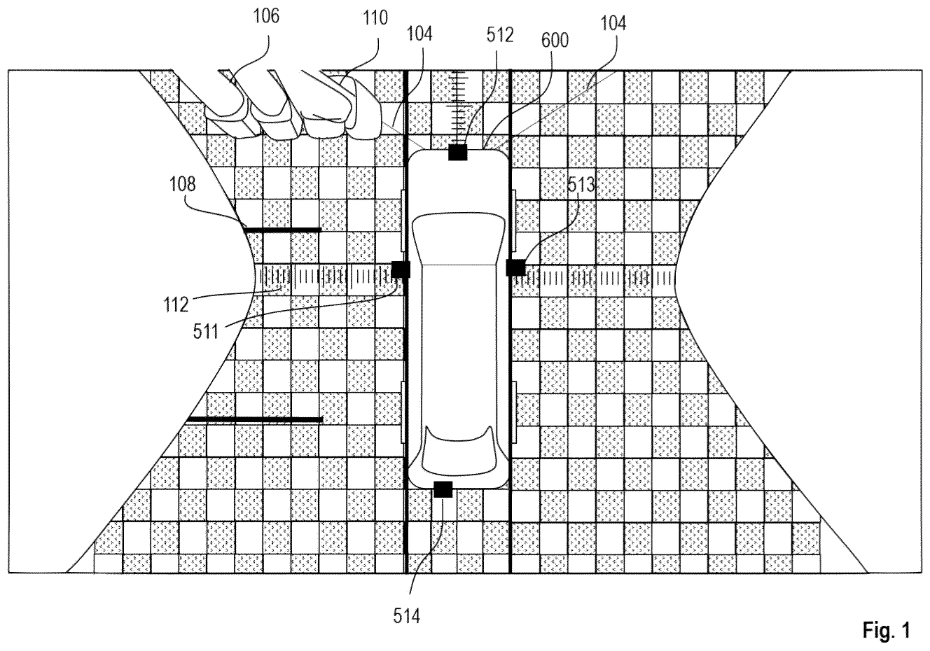

FIG. 1 shows the surround view of a vehicle 600, where the vehicle 600 is in a state, where the doors are closed. This is, for example, the case when the electrical system or the motor is started, or when the vehicle is moving. The surround view is represented by a bowl view, in which images from several cameras 511, 512, 513, 514 are combined to a single view. The cameras 511, 512, 513, 514 are mounted on the vehicle body. In this disclosure, it is distinguished between the rigid, i.e., fix, part of the vehicle body and movable or pivotable parts of the vehicle body such as doors and rotatable mirrors. Some of the cameras 511, 512, 513, 514 are mounted on such movable or pivotable parts. Usually, and also in the present case, the cameras 511, 512, 513, 514 are extrinsically calibrated with respect to the vehicle body. The calibration may be performed under reference conditions. Reference conditions may be in a defied surrounding with known objects and geometries with respect to these objects. The objects may include markings on walls or the floor or street. However, for further calibration, conditions for calibration may also be present, for example, when the vehicle 600 is in movement and all movable or rotatable parts are in a position corresponding to a driving scenario. That is, the doors are closed and the mirrors are adjusted. Therefore, the cameras 511, 512, 513, 514 may be re-calibrated also after the calibration under reference conditions. The re-calibration may be necessary because the vehicle body may rotate due to forces during driving that may be caused by the road condition or by driving maneuvers such as braking or accelerating, etc. In all these cases, the cameras are only very slightly rotated or moved with respect to the local vehicle coordinate system that is related to the vehicle body. FIG. 1 shows a surround view rendered by the views of the cameras 511, 512, 513, 514 under such calibrated or re-calibrated conditions. The squares in the figure may be interpreted as a common coordinate system of the calibrated cameras, which can be mapped to the vehicle body coordinate system. In the calibrated state, they are oriented all exactly in the same direction. The thick lines 108 show the orientation of the camera view of camera 511. Lines 112 represent a scale for distances. Some columns 106, 110 are shown, which provide a 3D-impression. A column 110 is shown at the intersection between the views of two cameras 511, 512, where the views merge. Lines 104 show the field of view of camera 512.

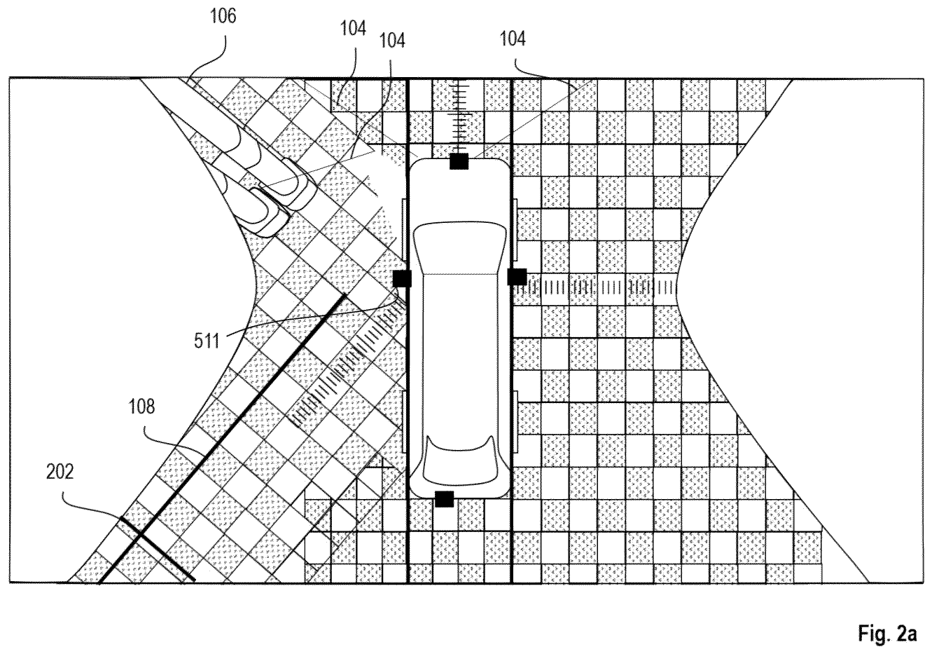

FIG. 2a shows a surround view when a door—in FIG. 2a the door on the left side of the vehicle—is open. In this case, the orientation of the view of camera 511 differs as can be seen by the thick lines and the orientation of the squares. The cameras still use the extrinsics of the calibration as described above. The camera coordinate system of camera 511 is rotated and displaced with respect to the common surround view coordinate system. Lines 108 and 202 the orientation of the view. The changed view is also recognizable in 3D by columns 106.

The processing unit that processes the images of the camera and produces the surround view, now detects that the vehicle is in a state where the door is open. The detection may be based on information from the cameras or on external information. The processing unit may for example evaluate the images of the surround view camera. For example, it may detect, that same objects are visible by two cameras, which normally should not be the case. As another example, the camera may detect by comparing an image with a previous image from this camera 511 and/or the further cameras 511, 513, 514 that a change of vehicle movement from driving to standstill or vice versa has taken place. In embodiments, this information may further be combined with an external information, for example that the motor has stopped. For this, external information from other sensors, controllers or driver assistance systems may be used.

FIG. 2b shows a sketch of the surround view where the camera is pivoted, and the angle is not taken into account. In this case, the view of the pivoted camera cannot be used for rendering the surround view and hence is eliminated. This results in a surround view where nearly the complete left side is a blind spot.

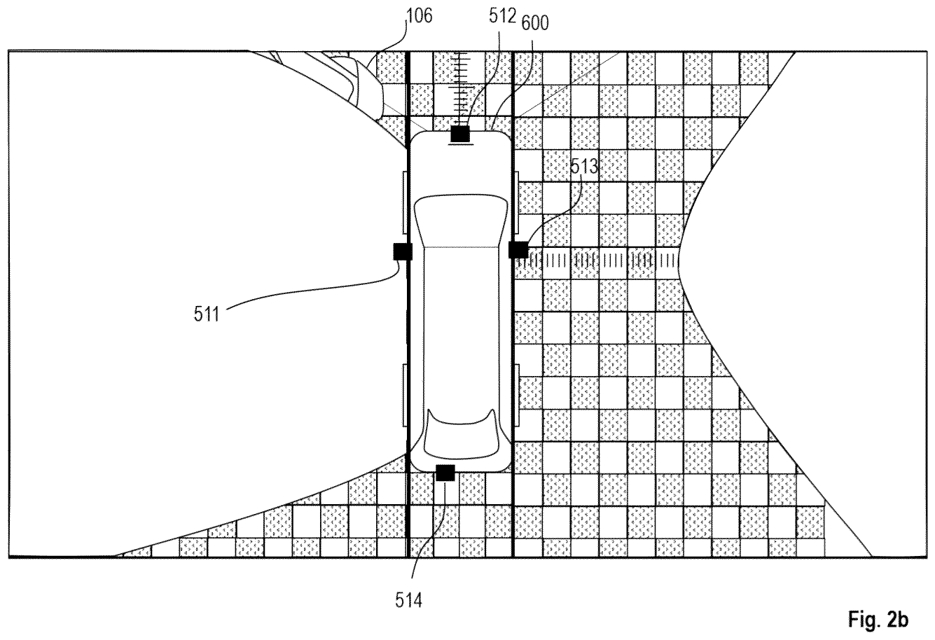

FIG. 3 shows the processed and rendered surround view, where the angle of the pivoted camera 511 has been taken into account and the processing unit has corrected the view as shown in FIG. 2a by the current door angle. The views are aligned again and the surround view can be composed using all camera views. The remaining blind spot in the surround view is caused by the field of view of camera 511, which may have an opening angle of 180° or less, and which therefore does not cover the complete left side when the door is open. Lines 108 and 202 show again the orientation of the view, which differs from the orientation of the pivoted camera. Additionally to the angle, also the distances may be fitted.

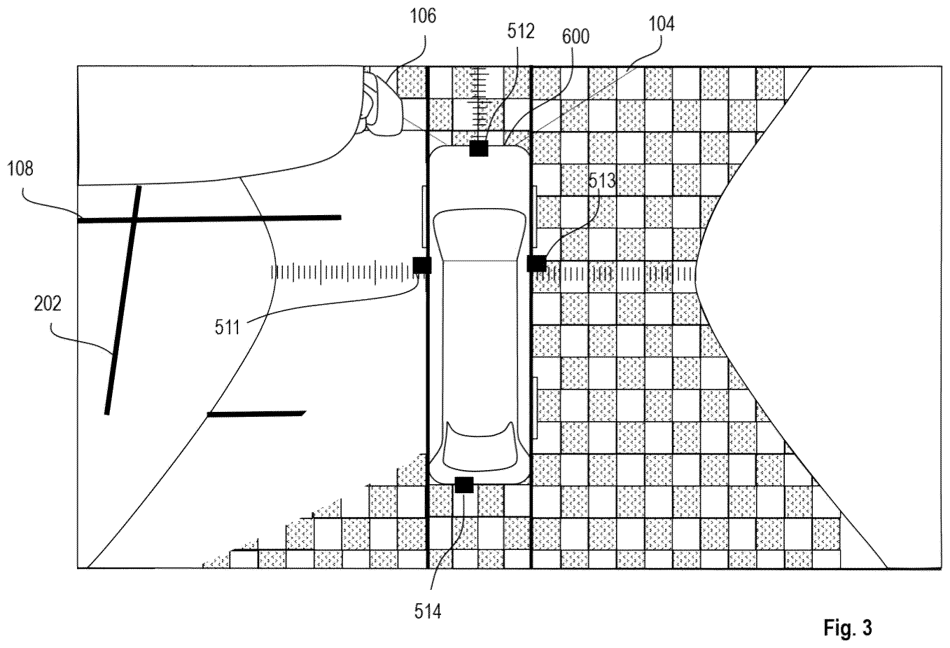

FIG. 4 shows a flow diagram representing the method 400 for rendering a surround view of a vehicle. The flow diagram serves as overview. The steps have been described in detail above so that the detailed description is not repeated at this point. In step 402, the electrical system of the vehicle and the motor are switched on. The vehicle may start to move, for example, at this step, or shortly after the next one or two steps. In step 404, the surround view system is switched on. The surround view system may be a human machine interface with a processing unit and a display to which optical sensors, which are in the following also referred to as “cameras”, are connected providing the optical sensor data, which are in the following also referred to as “images” or “image data”, for rendering the surround view. In step 406, the processing unit receives the first image data of a live a camera feed. Each image represents a view of the corresponding camera. In step 408, the processing unit calibrates the cameras using the first image data, and in step 410, the processing unit constructs the view, also using the first image data. The first image data are captured when the camera is not pivoted, for example, when the vehicle is moving. In step 412, the processing unit monitors the vehicle state and/or the vehicle dynamics. The vehicle state or vehicle dynamics may be obtained by evaluating the images of the cameras or by receiving external device or sensor information. If the state of the vehicle is not changed, i.e., for example the vehicle is still moving or the vehicle is still in running order, then the surround view is rendered in step 420 and the steps 406 to 412 are repeated. If, however, the processing unit detects, that the vehicle has stopped or is not in running order, for example, because a door is open, step 414 is performed. In step 414, the processing unit receives second optical sensor data from the optical sensor. The second optical sensor data contains second data where the optical sensor has a second angle with respect to the vehicle body due to pivoting the optical sensor. It is assumed that at the point of time when the vehicle stops, the door is not yet opened. The “first” image therefore might show a view where the door is still closed. The second image may thus captured with a delay with respect to the capturing of the second image. In step 416, the angle of the open door with respect to the closed door is estimated. This may happen, for example, using external sensor data or data contained in a data storage. In step 418, the view is reconstructed by taking into account the estimated angle. In step 420, the surround view is rendered using the reconstructed view of the pivoted camera, and the flow jumps back to step 406.

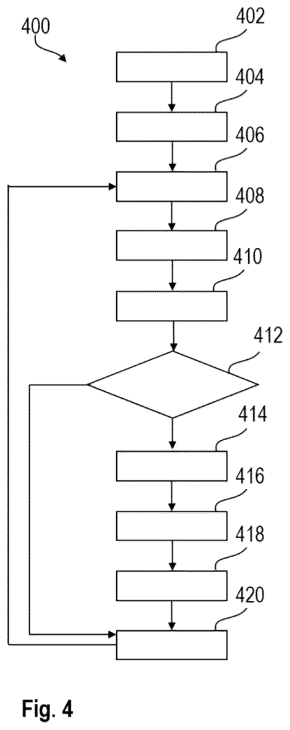

FIG. 5 shows a block diagram of a surround view system 500 comprising the processing unit 502 to which optical sensors 511, 512, 513, and 514 are connected. Further, the processing unit has access to a data storage 510, where the first optical sensor data, the second optical sensor data, and further data such as collected sensor data are at least temporarily stored, and has an interface 520 to external devices. The processing unit may also access external data by accessing external data storages or by receiving data directly from external sensors or devices 522.

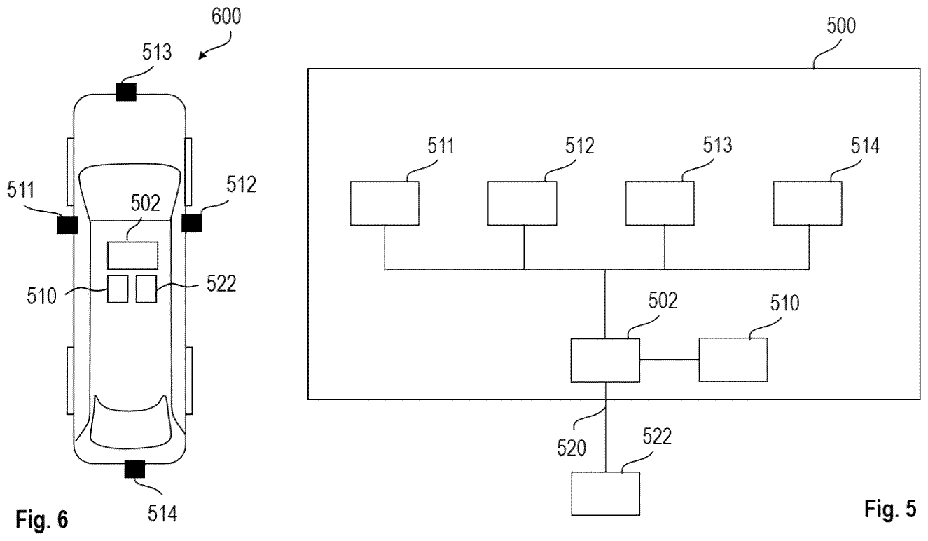

FIG. 6 shows a block diagram of a vehicle 600 comprising such a surround view system 500 with a processing unit 502 and optical sensors 511 . . . 514. The processing unit 502 may receive data from external sensors or external devices 522.

Some embodiments involve the use of one or more electronic processing or computing devices. As used herein, the terms “processor” and “computer” and related terms, e.g., “processing device,” “computing device,” and “controller” are not limited to just those integrated circuits referred to in the art as a computer, but broadly refers to a processor, a processing device, a controller, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processing (DSP) device, an application specific integrated circuit (ASIC), and other programmable circuits or processing devices capable of executing the functions described herein, and these terms are used interchangeably herein. The above embodiments are examples only, and thus are not intended to limit in any way the definition or meaning of the terms processor, processing device, and related terms.

### LIST OF REFERENCE SIGNS

104 lines indicating field of view of front camera 512
106 columns
108 lines indicating distances and orientation
110 column at the interface between the views of two cameras
112 lines representing a scale for distances
202 line indicating distance and orientation
400 method for rendering a surround view of a vehicle
402 . . . 420 processing steps of the method 400
500 surround view system
502 processing unit
510 data storage
511 first optical sensor/left camera
512 further optical sensor/front camera
513 further optical sensor/right camera
514 further optical sensor/rear camera
520 external data input
522 External sensors/devices
600 vehicle

1. A surround view system for a vehicle
comprising
a processing unit, configured to
receive first optical sensor data from an optical sensor, the first optical sensor data containing first data where the optical sensor has a first angle with respect to the vehicle body;
calibrate the optical sensor using the first optical sensor data; and
construct a view using the optical sensor data of the calibrated optical sensor;
detect an event related to pivoting the optical sensor;
receive second optical sensor data from the optical sensor upon detecting the event, the second optical sensor data containing second data where the optical sensor has a second angle with respect to the vehicle body due to pivoting the optical sensor based on the event;
estimate the difference of the first angle and the second angle;
reconstruct the view of the optical sensor using the second optical sensor data of the optical sensor having the second angle; and
render the surround view using the reconstructed view.

2. The surround view system according to claim 1, wherein the surround view system further comprises the optical sensor, wherein the optical sensor is mounted on a pivotable part of the vehicle body.

3. The surround view system according to claim 1, wherein the event is a change of a vehicle state and the processing unit is further configured
to monitor the vehicle state;
to perform the receiving first optical sensor data from an optical sensor, the calibrating the optical sensor using the first optical sensor data and the constructing a view using the optical sensor data of the calibrated optical sensor and rendering the surround view using the view, when the processing unit detects that the vehicle is in a first vehicle state; and
to perform the receiving second optical sensor data from an optical sensor, the estimating the difference of the first angle and the second angle, and the reconstructing the view and rendering the surround view using the reconstructed view, when the processing unit detects that the vehicle is in a second vehicle state.

4. The surround view system according to claim 3, wherein the vehicle state is whether the electrical system is switched on or off, the motor is running or not running, and/or the vehicle is moving or not moving.

5. The surround view system according to claim 1, wherein the processing unit is further configured to detect the event using the optical sensor data sensed by the optical sensor.

6. The surround view system according to claim 1, wherein the processing unit is further configured to detect the event using external vehicle data.

7. The surround view system according to claim 1, wherein the event is a pivoting of the pivotable part, and the processing unit is further configured to detect the pivoting of the pivotable part by receiving external sensor data.

8. The surround view system according to claim 1, wherein the processing unit is further configured to estimate the difference between the first and the second angle using stored vehicle data and/or external sensor data.

9. The surround view system according to claim 1, wherein the pivotable part of the vehicle body is a door of the vehicle.

10. The surround view system according to claim 1, wherein the surround view system comprises further a plurality of sensors, and the processing unit is further configured to receive optical data from the plurality of optical sensors and to render the surround view system using further the optical data of the plurality of optical sensors.

11. A processing unit in a surround view system for a vehicle, wherein the processing unit:
receives first optical sensor data from an optical sensor, the first optical sensor data containing first data where the optical sensor has first angle with respect to the vehicle body;
calibrates the optical sensor using the first optical sensor data;
constructs a view using the optical sensor data of the calibrated optical sensor;
detects an event related to pivoting the optical sensor;
receives second optical sensor data from the optical sensor upon detecting the event, the second optical sensor data containing second data where the optical sensor has a second angle with respect to the vehicle body;
estimates the difference of the first angle and the second angle; and
reconstructs the view of the optical sensor using the second optical sensor data of the optical sensor having the second angle and rendering the surround view using the reconstructed view.

12. A method for rendering a surround view of a vehicle, the method comprising:
receiving first optical sensor data from an optical sensor, the first optical sensor data containing first data where the optical sensor has first angle with respect to the vehicle body;
calibrating the optical sensor using the first optical sensor data
constructing a view using the optical sensor data of the calibrated optical sensor;
detecting an event related to pivoting the optical sensor;
upon detecting the event, receiving second optical sensor data from the optical sensor, the second optical sensor data containing second data where the optical sensor has a second angle with respect to the vehicle body due to pivoting the optical sensor based on the event;
estimating the difference of the first angle and the second angle; and
reconstructing the view of the optical sensor using the second optical sensor data of the optical sensor having the second angle; and
rendering the surround view using the reconstructed view.

13. A vehicle comprising a surround view system according to claim 1.

14. A non-transitory computer program that when executed by a processor causes the processor to implement a method for rendering a surround view of a vehicle according to claim 12.

15. A non-transitory computer readable medium having stored thereon a computer program that when executed by a processor causes the processor to implement a method for rendering a surround view of a vehicle according to claim 12.
